(19) United States
(12) Patent Application Publication
(10) Pub. No.: US 2023/0376849 A1
(43) Pub. Date: Nov. 23, 2023

(54) ESTIMATING OPTIMAL TRAINING DATA SET SIZES FOR MACHINE LEARNING MODEL SYSTEMS AND APPLICATIONS

(71) Applicant: NVIDIA Corporation, Santa Clara, CA (US)

(72) Inventors: Rafid Reza Mahmood, Mississauga (CA); Marc Law, Ontario (CA); James Robert Lucas, Royston (GB); Zhiding Yu, Cupertino, CA (US); Jose Manuel Alvarez Lopez, Mountain View, CA (US); Sanja Fidler, Toronto (CA)

(21) Appl. No.: 18/318,212

(22) Filed: May 16, 2023

Related U.S. Application Data
(60) Provisional application No. 63/344,007, filed on May 19, 2022.

(51) Int. Cl. G06N 20/00

(52) U.S. Cl. CPC G06N 20/00

(57) ABSTRACT

In various examples, estimating optimal training data set sizes for machine learning model systems and applications. Systems and methods are disclosed that estimate an amount of data to include in a training data set, where the training data set is then used to train one or more machine learning models to reach a target validation performance. To estimate the amount of training data, subsets of an initial training data set may be used to train the machine learning model(s) in order to determine estimates for the minimum amount of training data needed to train the machine learning model(s) to reach the target validation performance. The estimates may then be used to generate one or more functions, such as a cumulative density function and/or a probability density function, wherein the function(s) is then used to estimate the amount of training data needed to train the machine learning model(s).

### CROSS-REFERENCE TO RELATED APPLICATIONS

This application claims the benefit of U.S. Provisional Application No. 63/344,007, filed on May 19, 2022, which is hereby incorporated by reference in its entirety.

### BACKGROUND

Machine learning models are used in electronic devices for a variety of purposes, such as to perform tasks related to image classification, object detection, segmentation, content creation, navigation, and other tasks. Machine learning models learn to perform such tasks through a process by which they are trained using training data. Before a machine learning model is deployed in an electronic device, validation is performed to ensure that the machine learning model meets at least a target validation performance. For example, an object detection machine learning model may need to satisfy a minimum threshold precision before being deployed in a safety-critical application.

For a machine learning model, there may be a correlation between its validation performance and the amount of training data used in training. For a machine learning model that does not initially meet a target validation performance, a common technique to increase the validation performance is by collecting more training data to further train the machine learning model. However, collecting and annotating data used for training machine learning models may be both expensive and time consuming. For example, annotating segmentation data sets may require, e.g., 15 to 40 seconds per object such that annotating a data set of 100,000 images with on average of 10 cars per image may take an amount of time equivalent to between 170 and 460 days. As such, overestimating the amount of additional data needed to meet a target validation performance may cause the developer to incur unnecessary costs and man hours, while also requiring significant computing resources (e.g., processing power, storage, etc.). Moreover, over-training a machine learning model may degrade the machine learning model's ability to generalize beyond its training data. In contrast, underestimating the amount of additional training data needed to meet a target validation performance may result in the need to collect still more training data at a later stage, incurring further computational overhead and workflow delays. As such, it is important to determine how much additional training data is needed for a machine learning model to achieve a target validation performance.

### SUMMARY

Embodiments of the present disclosure relate to estimating optimal training data set sizes for machine learning model systems and applications. Systems and methods are disclosed that estimate an amount of data (e.g., a number of samples) to include in a training data set, where the training data set is then used to train one or more machine learning models to reach a target validation performance. To estimate the amount of training data, subsets of an initial training data set may be used to train the machine learning model(s) in order to determine estimates for the minimum amount of training data needed to train the machine learning model(s) to reach the target validation performance. For instance, the estimates may be used to generate one or more functions, such as a cumulative density function and/or a probability density function, wherein the function(s) is used to estimate the amount of training data needed to train the machine learning model(s). In some examples, one or more additional and/or alternative factors may be used to determine the amount of training data, such as one or more costs associated with the training data and/or a risk for failing to reach the target validation performance within the specified time period. Additionally, in some examples, the systems and methods may separate the amount of training data into different training data sets, where the training data sets are used to train the machine learning model(s) at various training stages.

In contrast to conventional systems, such as those described above, the current systems, in some embodiments, may use a density function (e.g., learned cumulative density function, probability density function, etc.) to estimate the amount of training data needed to train the machine learning model(s) to reach the target validation performance. As described herein, using the density function to estimate the amount of training data may improve the estimations by incorporating the uncertainty of the training when determining the amount of training data. Additionally, in contrast to the conventional systems, the current systems, in some embodiments, are able to estimate and then update the amounts of training data to retrieve at the various training stages of the machine learning model(s). This may reduce the risk of underestimating and/or overestimating the amount of training data, where underestimating and/or overestimating the amount of training data may cause unnecessary costs and time, and/or require a significant amount of computing resources. Furthermore, in contrast to the conventional systems, the current systems, in some embodiments, may incorporate the costs of training the machine learning model(s), such as the costs of the retrieving training data and/or the cost of not meeting the validation performance within a given time period, when estimating the amount of the training data.

### BRIEF DESCRIPTION OF THE DRAWINGS

The present systems and methods for estimating optimal training data set sizes for machine learning model systems and applications are described in detail below with reference to the attached drawing figures, wherein:

FIG. 1 illustrates an example data flow diagram for a process of estimating an optimal training data set size for training one or more machine learning models, in accordance with some embodiments of the present disclosure;

FIG. 2 illustrates an example of determining a density function, in accordance with some embodiments of the present disclosure;

FIG. 3 illustrates an example of determining amounts of training data to collect at various training stages for a machine learning model(s), in accordance with some embodiments of the present disclosure;

FIG. 4 is a data flow diagram illustrating a process for training a machine learning model(s), in accordance with some embodiments of the present disclosure;

FIG. 5 illustrates a flow diagram showing a method for estimating an amount of training data for a machine learning model(s), in accordance with some embodiments of the present disclosure;

FIG. 6 illustrates a flow diagram showing a method for estimating amounts of training data for training a machine learning model(s) at multiple training stages, in accordance with some embodiments of the present disclosure;

FIG. 7 illustrates a flow diagram showing a method for estimating an amount of training data for specific types of density functions, in accordance with some embodiments of the present disclosure;

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

Systems and methods are disclosed related to estimating optimal training data set sizes for machine learning model systems and applications. For instance, a system(s) may estimate the amount of training data (e.g., a number of training samples) needed to train one or more machine learning models to reach a target validation performance. In some examples, the machine learning model(s) is trained using one or more training stages and/or the machine learning model(s) needs to reach the target validation performance within a given time period. For instance, a user (e.g., a developer) that causes the training of the machine learning model(s) may indicate the given time period for training the machine learning model(s) and/or may indicate a number of training stages that may be used, within the given time period, to train the machine learning model(s). As described herein, the given time period may include, but is not limited to, 1 month, 6 months, 1 year, 5 years, and/or any other time period. Additionally, the number of training stages may include, but is not limited to, 1 stage, 2 stages, 3 stages, 5 stages, and/or any other number of stages.

In some examples, to estimate the amount of training data, the system(s) may initially determine a data requirement distribution associated with the amount of data needed to train the machine learning model(s). For example, the system(s) may determine one or more subsets of an initial training data set associated with the machine learning model(s). As described herein, a subset of the initial training data set may include a number of data samples (e.g., data points) such as, but not limited to, 10 samples, 20 samples, 50 samples, 100 samples, 1,000 samples, and/or any other number of samples. Additionally, the system(s) may determine a specific number of the subsets such as, but not limited to, 1 subset, 5 subsets, 10 subsets, 50 subsets, and/or any other number of subsets of the initial training data set. The system(s) may then train, using one or more iterations, the machine learning model(s) using the subset(s) of the initial training data set.

Based on the training, the system(s) may then analyze the iteration(s) of the machine learning model(s) to determine one or more validation scores associated with the machine learning model(s). For example, if the machine learning model(s) was trained using five subsets of the initial training data set, then the system(s) may determine at least a first validation score associated with the first subset, a second validation score associated with the second subset, a third validation score associated with the third subset, a fourth validation score associated with the fourth subset, and a fifth validation score associated with the fifth subset. The system(s) may then estimate an amount of training data needed to for the machine learning model(s) to reach the target validation performance using the results from the training. For example, the system(s) may use a function, such as a power law function, to estimate the amount of training data based on information associated with the subset(s) and the validation score(s). Additionally, the system(s) may perform similar processes, such as by using one or more additional groups of subsets of the initial training data set, to determine one or more additional estimates for the amount of training data needed to train the machine learning model(s) to reach the target validation performance.

The system(s) may then use the estimate(s) for the amount of training data to determine a density function associated with the amount of training data. For instance, the system(s) may make a mathematical assumption that the amount of training data is absolutely continuous and, as such, has a cumulative density function and/or a probability density function. As such, in some examples, the system(s) may determine the density function by fitting a kernel density estimator of the probability density function to the estimate(s). The system(s) may then perform one or more processes, such as numerical integration, to determine the cumulative density function associated with the amount of training data. In some examples, the cumulative density function may indicate the probability that a specific amount of training data is greater than the minimum amount of training data needed for the machine learning model(s) to reach the target validation performance.

The system(s) may then use the density function (e.g., the cumulative density function) to determine the amount of training data needed to train the machine learning model(s). In some examples, the system(s) may use one or more additional factors when determining the amount of training data, such as the costs for collecting additional training data and/or the cost of not reaching the target validation performance within the given period of time. In such examples, the user (e.g., the developer) may indicate the costs for collecting the additional training data and/or the cost for not reaching the target validation performance and/or the system(s) may use one or more set costs. In some examples, the system(s) may determine a respective amount of training data to collect at one or more of the training stage(s) used to train the machine learning model(s). For example, if the machine learning model(s) is to be trained using three training stages, then the system(s) may determine a first amount of training data (e.g., a first number of training samples) for training the machine learning model(s) during the first training stage, a second amount of training data (e.g., a second number of training samples) for training the machine learning model(s) during the second training stage, and a third amount of training data (e.g., a third number of training samples) for training the machine learning model(s) during the third training stage.

In some examples, the system(s) may continue to perform these processes in order to continue updating the amount(s) of training data until the machine learning model(s) reaches the target validation score and/or the period of time elapses. For instance, and using the example above where the machine learning model(s) is trained using three training stages, after the machine learning model(s) is trained using the first amount of training data during the first training stage, the system(s) may determine a current validation performance, such as a current validation score, associated with the machine learning model(s). If the system(s) determines that the current validation performance satisfies the target validation performance (e.g., the current validation score is equal to or greater than the target validation score), then the system(s) may determine that the training of the machine learning model(s) is complete. However, if the system(s) determines that the current validation performance does not satisfy the target validation performance (e.g., the current validation score is less than the target validation score), then the system(s) may determine to continue training the machine learning model(s).

For example, the system(s) may perform one or more of the processes descried herein to determine an updated density function. In some examples, and as described in more detail herein, the system(s) uses known information, such as the first amount of training data used to train the machine learning model(s) and/or the current validation performance when determining the updated density function. The system(s) may then use one or more of the processes described herein and the updated density function to determine an updated amount of training data needed to train the machine learning model(s) to reach the target validation performance. In some examples, and as described in more detail herein, the system(s) again uses known information, such as the first amount of training data used to train the machine learning model(s) and/or the current validation performance when determining the updated amount of training data. Additionally, in some examples, the system(s) performs these processes to determine a respective updated amount of training data to collect at one or more of the remaining training stages used to train the machine learning model(s).

For instance, and again using the example above where the machine learning model(s) is trained using three training stages, the system(s) may use the updated density function and/or the first amount of training data used to train the machine learning model(s) during the first training stage to determine an updated second amount of training data for training the machine learning model(s) during the second training stage and/or an updated third amount of training data for training the machine learning model(s) during the third training stage. The system(s) may then continue to perform these processes until the machine learning model(s) includes a validation performance that satisfies the target validation performance and/or until the given period of time elapses.

By performing the processes described herein, the system(s) may use the density function(s) to better estimate the amount of training data that is needed for the machine learning model(s) to reach the target validation performance. Additionally, by performing the processes described herein, the system(s) may be able to determine respective amounts of training data to use for training the machine learning model(s) not only at a current training stage, but one or more future training stages of the machine learning model(s). Furthermore, by performing the processes described herein, the system(s) may optimize the cost of both collecting the training data, such as at the various training stages, as well as the cost of not reaching the target validation performance within the given period of time.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, generative AI, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems for performing operations associated with a language model, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

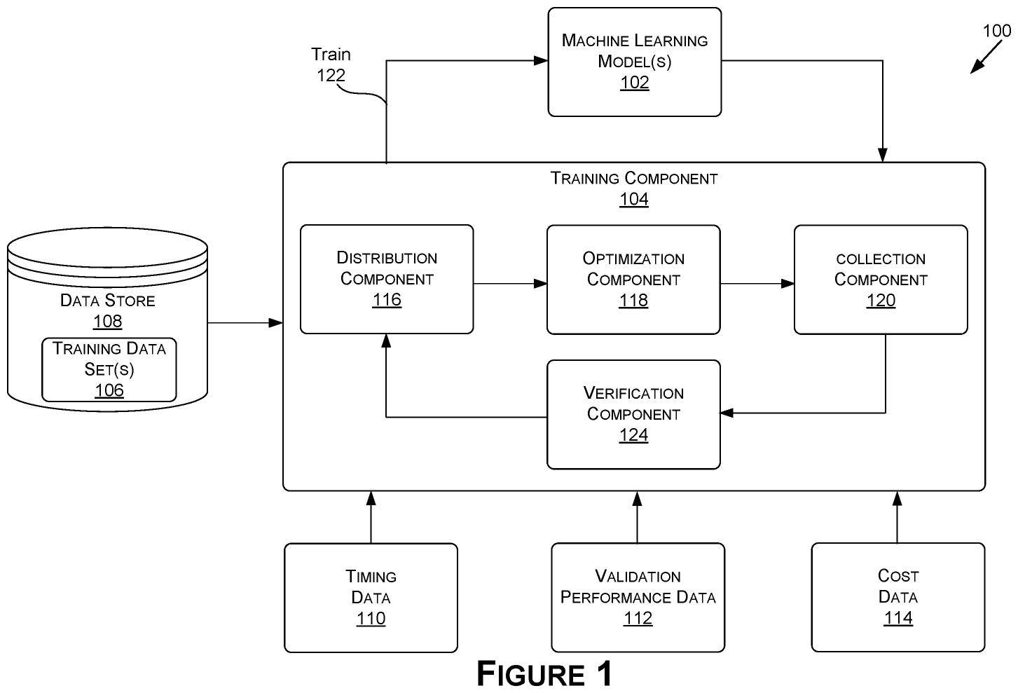

With reference to FIG. 1, FIG. 1 illustrates an example data flow diagram for a process 100 of estimating an optimal training data set size for training one or more machine learning models 102, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include a training component 104 receiving a training data set 106 that the training component 104 uses to train the machine learning model(s) 102. As described herein, the machine learning model(s) 102 is not restricted to any particular machine learning model architecture or neural network structure and may comprise, for example and without limitation, a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, one or more neural networks (e.g., auto-encoders, convolutional, recurrent, perceptrons, Long/Short Term Memory (LSTM), Hopfield, Boltzmann, deep belief, deconvolutional, generative adversarial, and/or liquid state machine, etc.), and/or other types of machine learning models.

In the example of FIG. 1, the training component 104 may receive the training data set 106 from a data store 108. In some examples, the data store 108 may be an element of the training component 104. In some examples, the data store 108 may be coupled to and/or accessible by the training component 104 via one or more networks. Additionally, the training data set 106 may represent image data representing images, video data representing videos, audio data representing sound (e.g., user speech, words, specific noises, etc.), text data representing text (e.g., words, numbers, letters, punctuation marks, etc.), sensor data (e.g., radar data, LiDAR data, etc.), simulation data, and/or any other type of data that may be used to train the machine learning model(s) 102. In some examples, the training data set 106 is specific to the task for which the machine learning model(s) 102 is being trained to perform. For a first example, if the machine learning model(s) 102 is being trained for object detection, then the training data set 106 may include images depicting various objects, annotations associated with the objects, and/or ground truth data associated with the images. For a second example, if the machine learning model(s) 102 is being trained for speech recognition, then the training data set 106 may include audio data representing user speech and/or ground truth data representing text associated with the user speech.

The process 100 may further include the training component 104 receiving additional data that the training component 104 uses to train the machine learning model(s) 102. In some examples, the training component 104 may receive the additional data from one or more devices, such as from one or more user devices associated with one or more users (e.g., one or more developers) for which the machine learning model(s) 102 is being trained. For instance, the training component 104 may receive timing data 110 representing at least a given time period for which the machine learning model(s) 102 is to be trained and/or a number of training stages to use when training the machine learning model(s) 102. As described herein, the given time period may include, but is not limited to, 1 month, 6 months, 1 year, 5 years, and/or any other time period. Additionally, the number of training stages may include, but is not limited to, 1 stage, 2 stages, 3 stages, 5 stages, and/or any other number of stages.

The training component 104 may further receive validation performance data 112 representing one or more validation performances that the machine learning model(s) 102 should achieve during the training. As described herein, the validation performance of the machine learning model(s) 102 may relate to performance metrics such as, without limitation, accuracy, precision, recall, Intersection over Union (IoU), or other performance metric(s). For a first example, if the machine learning model(s) 102 is being trained for object detection, then the validation performance data 112 may indicate a validation score of 95%. As such, after training, the machine learning model(s) 102 should be able to accurately identify objects within images with an accuracy that satisfies (e.g., is equal to or greater that) 95%. For a second example, if the machine learning model(s) 102 is being trained for speech recognition, then the validation performance data 112 may indicate a validation score of 99%. As such, after training, the machine learning model(s) 102 should be able to accurately identify text represented by audio with an accuracy that satisfies (e.g., is equal to or greater than) 99%.

The training component 104 may further receive cost data 114 representing one or more costs associated with training the machine learning model(s) 102. In some examples, the cost(s) may be associated with generating and/or receiving the training data set. For a first example, the training data set 106 may include a number of data samples (e.g., images, audio recordings, etc.), where there is a cost for generating and/or annotating one or more of the data samples within the training data set 106. For a second example, the training data set 106 may include different types of training data, where there are different costs for the different types of training data. For instance, if the training data set 106 includes sensor data and simulation data, then there may be a first cost associated with generating the sensor data and a second, different cost associated with generating the simulation data. Additionally, or alternatively, in some examples, the cost(s) may include a cost (e.g., price) associated with not reaching the target validation performance within the given period of time. For instance, if the given period of time is three years and the target validation performance includes a target validation score of 99%, then there may be a cost associated with the machine learning model(s) 102 not reaching the target validation score within the three-year period.

The process 100 may include the training component 104 training the machine learning model(s) 102 using the training data set 106, the timing data 110, the validation performance data 112, and/or the cost data 114. In some examples, in order to efficiently and/or timely train the machine learning model(s) 102, the training component 104 may determine (e.g., estimate) an optimal amount of training data (e.g., an optimal number of training samples) to use to train the machine learning model(s) 102. As described herein, the optimal amount of training data may train the machine learning model(s) 102 to reach the target validation performance without unnecessarily overtraining the machine learning model(s) 102 with excess training data. For example, the optimal amount of training data may be associated with the minimum amount of training data needed for training such that the machine learning model(s) 102 still reaches the target validation performance.

For instance, consider Kϵ [symbol] N different data sources, where for one or more (e.g., each) kϵ{1, . . . , K}, zₖ may be a data point and D^{k} may be a data point set. The training component 104 may thus train the machine learning model(s) 102 with data sets D¹, . . . , D^{k} and evaluate a score function V(D¹, . . . , D^{K}). For example, if the learning problem is binary image classification, let K=1 where z₁:=(x, y) corresponds to images xϵX and labels yϵ{0,1}, and V(D¹) is the validation set accuracy of the machine learning model(s) 102 trained on D¹. Alternatively, in semi-supervised learning, let K=2 where the additional z₂:=x corresponds to unlabeled images and V(D¹, D²) is the validation accuracy of the machine learning model(s) 102 trained with both data sets. For another example, for domain adaptation, let z₁ and z₂ be image-label pairs generated from a source and target distribution respectively, while V(D¹, D¹) is the target domain validation accuracy.

D_{q}_{_{0,}}₁,¹, . . . , D_{q}_{_{0,}}_{K}^{K}q_{0,1}, . . . q_{0,K}V*>D_{q}_{_{0,}}₁¹, . . . , D_{q}_{_{0,}}_{K}^{K}Tq₀:=(q_{0,1}, . . . , q_{0,K})^{T}V_{q}_{₀}:=VD_{q}_{_{0,}}₁¹, . . . , D_{q}_{_{0,}}_{K}^{K})tϵ{1, . . . , T}qₜ:=(q_{0,1}, . . . , q_{0,K})^{T}D^{k}q_{t,k}V_{q}_{ₜ}≥V*t=TTAs, such in general, the training component 104 may have training data sets of points (e.g., samples), respectively, a target validation score

D_{q}_{_{0,}}₁,¹, . . . , D_{q}_{_{0,}}_{K}^{K}q_{0,1}, . . . q_{0,K}V*>D_{q}_{_{0,}}₁¹, . . . , D_{q}_{_{0,}}_{K}^{K}Tq₀:=(q_{0,1}, . . . , q_{0,K})^{T}V_{q}_{₀}:=VD_{q}_{_{0,}}₁¹, . . . , D_{q}_{_{0,}}_{K}^{K})tϵ{1, . . . , T}qₜ:=(q_{0,1}, . . . , q_{0,K})^{T}D^{k}q_{t,k}V_{q}_{ₜ}≥V*t=TT, and a horizon of rounds. As such, let be a vector of training data set sizes and let (. For each , the training component 104 may (1) determine how much data to have at the end of the round

D_{q}_{_{0,}}₁,¹, . . . , D_{q}_{_{0,}}_{K}^{K}q_{0,1}, . . . q_{0,K}V*>D_{q}_{_{0,}}₁¹, . . . , D_{q}_{_{0,}}_{K}^{K}Tq₀:=(q_{0,1}, . . . , q_{0,K})^{T}V_{q}_{₀}:=VD_{q}_{_{0,}}₁¹, . . . , D_{q}_{_{0,}}_{K}^{K})tϵ{1, . . . , T}qₜ:=(q_{0,1}, . . . , q_{0,K})^{T}D^{k}q_{t,k}V_{q}_{ₜ}≥V*t=TT, (2) generate training data until each has points, and (3) retrain the machine learning model(s) 102 unless or, in which case the training may be terminated. In such examples, may represent the given number of training rounds represented by the timing data 110.

In some examples, for one or more (e.g., each) of the training round(s) (e.g., represented by the timing data 110), a cost cₖ>0 may be paid for one or more (e.g., each) additional point generated for the k-th data set. Furthermore, if the training component 104 does not reach the target validation performance V* after T training rounds, a penalty P may be paid. As such, let c:=(c₁, . . . , c_{K})^{T} be a cost vector associated with the training. Then, the problem to determine the optimal amount of training data may include:

$${min}_{{q}_{1} \leq … \leq {q}_{T}} {c}^{⊤} ( {q}_{1} - {q}_{0} ) + \{ {V}_{{q}_{1}} < {V}^{*} \} ( {c}^{⊤} ( {q}_{2} - {q}_{1} ) + \{ {V}_{{q}_{2}} < {V}^{*} \} ( {c}^{⊤} ( {q}_{3} - {q}_{2} ) ⋮ + \{ {V}_{{q}_{T - 1}} < {V}^{*} \} ( {c}^{⊤} ( {q}_{T} - {q}_{T - 1} ) + P \{ {V}_{{q}_{T}} < {V}^{*} \} ) … ) ) \qquad ( 1 )$$

In some examples, equation (1) may be defined recursively where the objective includes the cost of collecting additional training data at each round t and then conditioned on not collecting enough training data in that round. As such, the equation (1) continues to the next round.

If the training component 104 uses randomized algorithms to train the machine learning model(s) 102 and to sample data, the score function is a random variable. Moreover, the score function may typically increase monotonically with the size of the training data set 106. As such, it may be assumed that the score function is a stochastic process V_{q}:=V(D¹, . . . , D^{K}) as a function of the size of the training data set 106 (e.g., the number of training samples included in the training data set 106). Furthermore, this process may increase monotonically with q. As such, the data collection problem may be rewritten as:

$${min}_{{q}_{1} \leq … \leq {q}_{T}} {\sum }_{t = 1}^{T} {c}^{⊤} ( {q}_{t} - {q}_{t - 1} ) {\prod }_{s = 1}^{t - 1} \{ {V}_{{q}_{s}} < {V}^{*} \} + P {\prod }_{t = 1}^{T} \{ {V}_{{q}_{t}} < {V}^{*} \} = {min}_{{q}_{1} \leq … \leq {q}_{T}} {\sum }_{t = 1}^{T} {c}^{⊤} ( {q}_{t} - {q}_{t - 1} ) \{ {V}_{{q}_{t - 1}} < {V}^{*} \} + P \{ {V}_{{q}_{T}} < {V}^{*} \} \qquad ( 2 )$$

In equation (2), the second line follows from the fact that since q₁≤ . . . ≤q_{T}, the product of the indicators is equivalent to the maximum.

In some examples, equation (2) is associated with collecting the minimum training data q (e.g., the optimal amount of training data) such that V_{q}≥V*. In some examples, this minimum training data requirement is the stopping time of the stochastic process:

$${D}^{*} := \begin{matrix}argmin \\ q\end{matrix} \{ {c}^{⊤} q \vert {V}_{q} \geq {V}^{*} \} \qquad ( 3 )$$

In Equation (3), D* is a random variable that gives the lowest-cost index that passes V*. In some examples, if P<c^{T}(D*-q₀), then an optimal solution to equation (2) may include the following, q₁^{*}= . . . =q_{T}^{*}=q₀. Otherwise, an optimal solution to equation (2) may include the following, q₁^{*}= . . . =q_{T}^{*}=D*.

In order to determine the optimal amount of training data for training the machine learning model(s) 102, the process 100 may include the training component 104 using a distribution component 116 to determine a data requirement distribution. For example, the distribution component 116 may determine one or more subsets of the training data set 106 associated with the machine learning model(s) 102. As described herein, a subset of the training data set 106 may include a number of data points (e.g., data samples) such as, but not limited to, 10 points, 20 points, 50 points, 100 points, 1,000 points, and/or any other number of points. Additionally, the system(s) may determine a specific number of the subsets such as, but not limited to, 1 subset, 5 subsets, 10 subsets, 50 subsets, and/or any other number of subsets of the training data set 106. The distribution component 116 may then train, using one or more iterations, the machine learning model(s) 102 using the subset(s) of the training data set 106.

Based on the training, the distribution component 116 may analyze the iteration(s) of the machine learning model(s) 102 to determine one or more validation performances (e.g., one or more validation scores) associated with the machine learning model(s) 102. For example, if the machine learning model(s) 102 was trained using five subsets of the training data set 106, then the distribution component 116 may determine at least a first validation performance associated with the first subset, a second validation performance associated with the second subset, a third validation performance associated with the third subset, a fourth validation performance associated with the fourth subset, and a fifth validation performance associated with the fifth subset. The distribution component 116 may then estimate an amount of training data needed for the machine learning model(s) 102 to reach the target validation performance using the results from the training. For example, the distribution component 116 may use a function, such as a power law function, to estimate the amount of training data based on information associated with the subset(s) and the validation performance(s). Additionally, the distribution component 116 may perform similar processes, using one or more additional groups of subsets of the training data set 106, to determine one or more additional estimates for the amount of training data needed to train the machine learning model(s) 102 to reach the target validation performance.

The distribution component 116 may then use the estimate(s) for the amount of training data to determine a density function associated with the amount of training data. For instance, the distribution component 116 may make a mathematical assumption that the amount of training data is absolutely continuous and, as such, has a cumulative density function (CDF) and/or a probability density function (PDF). As such, in some examples, the distribution component 116 may determine the density function by fitting a kernel density estimator of the PDF to the estimate(s). The distribution component 116 may then perform one or more processes, such as numerical integration, to determine the CDF associated with the amount of training data. In some examples, the CDF may indicate the probability that a specific amount of training data is greater than the minimum amount of training data needed for the machine learning model(s) 102 to reach the target validation performance.

For an example of determining the probability distribution, the distribution component 116 may initially input an initial data set D_{q}, a regression model \hat{v}(q;θ), a regression size R, a number of bootstrap samples B, and a kernel density estimation (KDE) model \hat{f}(q). The distribution component 116 may then initialize [symbol] =Ø, \dot{D}=Ø, and then update [symbol] by collecting performance statistics. For example, the distribution component 116 may subsample from the data sets D_{q}_{_{t,1}}¹, . . . , D_{q}_{_{t,K}}^{K} to simulate small data set sizes, retrain the machine learning model(s) 102, and evaluate the performance scores associated with the retrained machine learning model(s) 102. In some examples, the distribution component 116 may then repeat this process with R different training subsets to yield a data set of training statistics [symbol] :={qᵣ, V_{q}_{ᵣ}}ᵣ₌₁^{R}, which may be used to solve a Least Squares minimization problem. Once fitted, v(q;θ*) may replace V_{q} in equation (3).

The distribution component 116 may then initialize [symbol] =Ø. For instance, and for bϵ{1, . . . , B}, the distribution component 116 may create a bootstrap [symbol] _{b} by sub-sampling R points with replacement from [symbol] , fit regression model θ*=argmin_{θ} [symbol] (V_{q}-v(q;θ))², estimate the data requirements \hat{q}_{b}=argmin_{q}{c^{T}q|v(q;θ*)≥V*}, and update [symbol] ← [symbol] . The distribution component 116 may then fit the KDE model \hat{f}(q) using the empirical distribution [symbol] and \hat{F}(q):=∫₀^{q}\hat{f}(q)/dq. Based on performing such processes, the distribution component 116 may determine that the output is the estimate of the requirement distribution \hat{F}(q).

For more detail, the distribution component 116 may estimate the cumulative probability F(q):=Pr{D*≤q}. For one or more solutions q (e.g., any solution) to equation (2), if q≥D*, then V_{q}≥V*. As such, F(q) may upper bound on the probability of collecting enough data to meet the target validation performance. In some examples, to more easily estimate the later use of this probability, it may be assumed that D* is a continuous random variable. For instance, a mathematical assumption may be used that models the random variable D* as being absolutely continuous such that D* has a CDF F(q) and a PDF f (q):=dF(q)/dq.

As such, the distribution component 116 may let \hat{F}(q) be an estimate of the CDF obtained by bootstrapping the point estimates of D*. The distribution component 116 may then perform the steps above to create the regression set of training statistics [symbol] . Also, the distribution component 116 may let B>1 be the number of bootstrap estimates. As such, for one or more (e.g., each) bϵ{1, . . . , B}, the distribution component 116 may create a bootstrap resampled set of [symbol] and solve a corresponding Least Square minimization problem to fit a scaling law estimator v_{b}(q;θ_{b}) with parameters θ_{b}. The distribution component 116 may then use this in place of V_{q} in equation (3) to estimate the minimum data requirement. After repeating this process, the distribution component 116 may obtain a bootstrap set of estimates {\hat{D}_{b}}_{b=1}^{B}, which the distribution component 116 may use to fit a kernel density estimator \hat{f}(q) of the PDF of the data requirement.

Numerical integration may then yield the CDF \hat{F}(q):=∫₀^{q}\hat{f}f(q)/dq.

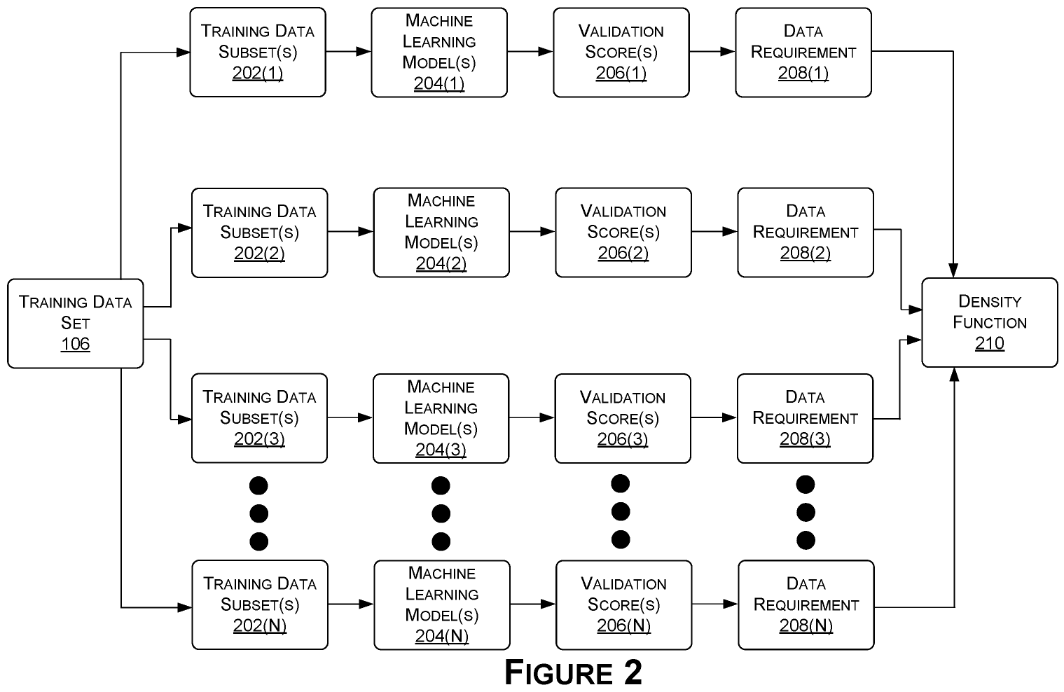

For instance, FIG. 2 illustrates an example of determining a density function, in accordance with some embodiments of the present disclosure. As shown, the distribution component 116 may separate the training data set 106 into various groups of training data subset(s) 202(1)-(N) (also referred to singularly or in plural as “training data subset(s) 202”). As described herein, a training data subset 202 may include 10 points, 20 points, 50 points, 100 points, 1,000 points, and/or any other number of points. Additionally, a group of the training data subset(s) 202 may include 1 subset, 5 subsets, 10 subsets, 50 subsets, and/or any other number of subsets of the training data set 106. For example, the training data subset(s) 202(1) may include five different subsets of the training data set 106, where a first subset includes 5 points, a second subset includes 10 points, a third subset includes 15 points, a fourth subset includes 20 points, and a third subset includes 25 points.

The distribution component 116 may then use the training data subset(s) 202 to train machine learning models 204(1)-(N) (also referred to singularly as “machine learning model(s) 204” or in plural as “machine learning model(s) 204”). In some examples, one or more (e.g., each) of the machine learning models 204 may include the same machine learning model(s), such as the machine learning model(s) 102. Once trained, the distribution component 116 may determine validation scores 206(1)-(N) (also referred to singularly as “validation score(s) 206” or in plural as “validation score(s) 206”) associated with the machine learning models 204. For example, the distribution component 116 may test the machine learning models 204 using additional data. Based on the testing, the distribution component 116 may determine the accuracies of the machine learning models 204, where the validation scores 206 are associated with the accuracies.

As further shown by the example of FIG. 2, the distribution component 116 may then perform one or more of the processes described herein, such as using least square minimization problems, to determine respective estimates for data requirements 208(1)-(N) (also referred to singularly as “data requirement 208” or in plural as “data requirements 208”) for each of the sets of the validation scores 206. For instance, the data requirements 208 may include the estimates of D*. The distribution component 116 may then perform one or more of the processes described herein to determine a density function 210, such as the CDF, using the data requirements 208.

Referring back to the example of FIG. 1, the process 100 may include the training component 104 using an optimization component 118 to determine an amount of training data (e.g., a number of training samples) needed to train the machine learning model(s) 102 in order to reach the target validation performance. As described herein, the optimization component 118 may determine the amount of training data by optimizing the collection cost plus the risk of failing to meet the target validation performance before the elapse in the given time period. Additionally, in some examples, the optimization component 118 may determine a respective amount of training data to collect at one or more of the training stage(s) used to train the machine learning model(s) 102. For example, if the machine learning model(s) 102 is to be trained using three training stages, then the optimization component 118 may determine a first amount of training data (e.g., a first number of training samples) for training the machine learning model(s) 102 during the first training stage, a second amount of training data (e.g., a second number of training samples) for training the machine learning model(s) 102 during the second training stage, and a third amount of training data (e.g., a third number of training samples) for training the machine learning model(s) 102 during the third training stage.

For more detail, in some examples, solving equation (2) directly may be difficult because evaluating whether a given amount of training data q is sufficient to reach V* may require collecting the training data itself and training the machine learning model(s) 102. As such, in order to leverage the density estimator, and since D* is an optimal solution, the optimization component 118 may consider the following equation as an approximation to the original problem:

$${min}_{{q}_{1} \leq … \leq {q}_{T}} {\sum }_{t = 1}^{T} {c}^{⊤} ( {q}_{t} - {q}_{t - 1} ) \{ {q}_{t - 1} ≱ {D}^{*} \} + P \{ {q}_{T} ≱ {D}^{*} \} \qquad ( 4 )$$

As shown, equation (4) may replace the condition of achieving V* from equation (2) with the condition of collecting at least D* points over all of the data sources. Additionally, in some examples, such as when K=1, equation (4) is similar to equation (2). Furthermore, for general K, equation (4) and equation (2) may not be exact equivalents based on the multiple data sources, such that q [symbol] D* and V₁≥V*, but equation (4) and equation (2) may still share the same optimal solution.

In some examples, the approximation of equation (4) may nonetheless be difficult to solve as it may rely on D*, which may not be a priori. However, since D* is a random variable, the distribution component 116 estimated the CDF of \hat{F}(q). As such, the optimization component 118 may formulate the following stochastic optimization equation:

$${min}_{{q}_{1} \leq … \leq {q}_{T}} {\sum }_{t = 1}^{T} {c}^{⊤} ( {q}_{t} - {q}_{t - 1} ) ( 1 - \hat{F} ( {q}_{t - 1} ) ) + P ( 1 - \hat{F} ( {q}_{T} ) ) = {min}_{{d}_{1} , … , {d}_{T} \geq 0} {\sum }_{t = 1}^{T} {c}^{⊤} {d}_{t} ( 1 - \hat{F} ( {q}_{0} + {\sum }_{s = 1}^{t - 1} {d}_{s} ) ) + P ( 1 - \hat{F} ( {q}_{0} + {\sum }_{t = 1}^{T} {d}_{t} ) ) \qquad ( 5 )$$

In equation (5), the second line may reformulate the objective to a function of the additional training data to collect dₜ:=qₜ-qₜ₋₁ for one or more (e.g., each) training round tϵ{1, . . . , T}. Additionally, the variables of equation (5) may only be constrained to non-negativity. Furthermore, although d₁, . . . , d_{T}ϵ [symbol] ₊^{K} should be discrete values, the optimization component 118 may relax the integrality requirement similar to the modeling of D* in equation (2). As a result, equation (5) may be treated as a continuous optimization problem with only non-negative constraints, which may be optimized via gradient descent algorithms.

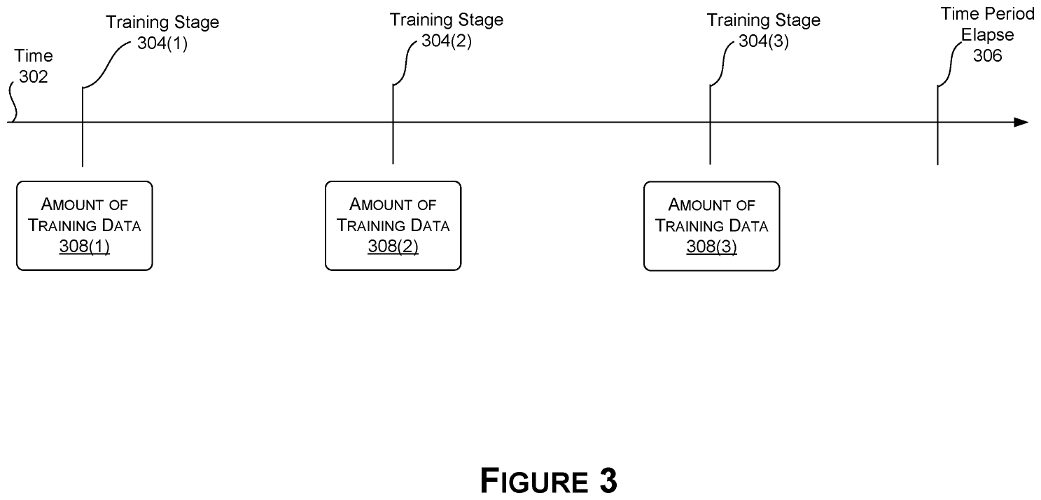

For instance, FIG. 3 illustrates an example of determining amounts of training data to collect at various training stages for a machine learning model(s), in accordance with some embodiments of the present disclosure. As shown in the example of FIG. 3, the machine learning model(s) (e.g., the machine learning model(s) 102) may be trained over a period of time 302 using three training stages 304(1)-(3) (also referred to singularly as “training stage 304” or in plural as “training stages 304”). Additionally, the machine learning model(s) may need to be trained such that the machine learning model(s) reaches a target validation performance within a given time period that starts at the first training stage 304(1) and ends at a time period elapse 306.

As further shown in the example of FIG. 3, the optimization component 118 may perform the processes described herein to determine a first amount of training data 308(1) to use to train the machine learning model(s) during the first training stage 304(1), a second amount of training data 308(2) to use to train the machine learning model(s) during the second training stage 304(2), and a third amount of training data 308(3) to use to train the machine learning model(s) during the third training stage 304(3). In some examples, the amounts of training data 308(1)-(3) may be similar to one another. In other examples, one or more of the amounts of training data 308(1)-(3) may be different than one or more other amounts of training data 308(1)-(3). While the example of FIG. 3 illustrates determining three amounts of training data 308(1)-(3) for three different training stages 304, in other examples, the optimization component 118 may determine any number of amounts of training data for any number of training stages.

Referring back to the example of FIG. 1, in some examples, such as when T =1 (e.g., there is only a single training stage), the optimization component 118 may perform one or more additional and/or alternative processes to determine the amount of training data needed to train the machine learning model(s) 102 to reach the target validation performance V*. For instance, and in such a scenario, the training usually features a single data type, such that K=1, a potentially zero or limited initial training data set q₀, and a noisy estimator \hat{F}(q) of the data requirement F(q). In some examples, this T=1 and K=1 settings may permit a theoretical analysis, including an exact solution d₁^{*} with interpretable insights.

For instance, and as discussed above, the penalty P reflects the consequence if the machine learning model(s) 102 does not reach the target validation performance V*, where it may be difficult to determine the appropriate P in practice. As such, the optimization component 118 may consider a more intuitive parameter ϵ≥0 to measure the probability of not meeting V*. Since the data requirement D* is stochastic, E may represent how much a user is willing to tolerate the chance of not collecting enough training data. That is, the training component 104 should collect enough training data d₁ such that F(q₀+d₁)≥1-ϵ. As such, the optimization component 118 may determine that if there exists d₁≥0 where:

$$\frac{c}{P} \leq \frac{\hat{F} ( {q}_{0} + {d}_{1} ) - \hat{F} ( {q}_{0} )}{{d}_{1}} \qquad ( 6 )$$

then there also exists an ϵ≤1-\hat{F}(q₀) that satisfies P=c/\hat{ƒ}(\hat{F}⁻¹(1-ϵ)) and an optimal solution to the T=1, K=1 for equation (5) that is d₁^{*}:=\hat{F}⁻¹(1-ϵ)-q₀. Otherwise, the optimization component 118 may determine that d₁^{*}=0.

In other words, when the ratio of c/P is sufficiently small, the optimization component 118 may determine the optimal single training stage estimate for the training data requirement by taking a 1-ϵ quantile of the distribution of D*. This may mean that when T=1 and K=1, rather than determining values for c and P and then solving equation (5), the optimization component 118 may instead just prescribe a maximum acceptable risk of failing to collect enough data ϵ:=Pr{q₀+d₁<D*} and then collect d₁^{*}=\hat{F}⁻¹(1-ϵ)-q₀ additional points. Alternatively, if there is a well-defined P for a given application, the optimization component 118 may map the problem parameters to the corresponding risk tolerance ϵ that satisfies c/\hat{ƒ}(\hat{F}⁻¹(1-ϵ)) and again obtain the optimal solution.

In some examples, the optimization component 118 may use an analytic solution for specific distributions of D*, such as a Gaussian Distribution. For instance, the training data requirement may be unimodular and be approximated with simple distributions. For instance, suppose that \hat{F}(q)˜ [symbol] (\hat{μ},\hat{σ}) is Gaussian and ζ:=\sqrt{logP-log(c\hat{σ}√2π).} As such, in some examples, the optimization component 118 may determine that if the initial amount of training data q₀ is less than or equal to a first value, such that q₀≤\hat{μ}-√2\hat{σ}ζ, then:

$${d}_{1}^{*} \{ \begin{matrix}\hat{μ} + \sqrt{2} \hat{σ} ζ - {q}_{0} if \frac{c}{P} \leq min \{ \frac{erf ζ}{2 \sqrt{2} \hat{σ} ζ} , \frac{erf ( \frac{\hat{μ} - {q}_{0}}{\hat{σ} \sqrt{2}} ) + erf ζ}{2 ( \hat{μ} + \sqrt{2} \hat{σ} ζ - {q}_{0} )} \} \\ \hat{μ} + \sqrt{2} \hat{σ} ζ - {q}_{0} if \frac{erf ζ}{2 \sqrt{2} \hat{σ} ζ} \leq \frac{c}{P} \leq \frac{erf ( \frac{\hat{μ} - {q}_{0}}{\hat{σ} \sqrt{2}} ) + erf ζ}{2 ( \hat{μ} + \sqrt{2} \hat{σ} ζ - {q}_{0} )} \\ 0 otherwise\end{matrix} \qquad ( 7 )$$

Additionally, in some examples, the optimization component 118 may determine that if the initial amount of training data q₀ is greater than the first value and less than or equal to a second value, such that \hat{μ}-√2\hat{σ}ζ<q₀≤\hat{μ}+√2\hat{σ}ζ, then:

$${d}_{1}^{*} \{ \begin{matrix}\hat{μ} + \sqrt{2} \hat{σ} ζ - {q}_{0} if \frac{c}{P} \leq \frac{erf ( \frac{\hat{μ} - {q}_{0}}{\hat{σ} \sqrt{2}} ) + erf ζ}{2 ( \hat{μ} + \sqrt{2} \hat{σ} ζ - {q}_{0} )} \\ 0 otherwise\end{matrix} \qquad ( 8 )$$

q₀q₀>\hat{μ}+\sqrt{2}\hat{σ}ζdᵢ^{*}=0 Furthermore, in some examples, the optimization component 118 may determine that if the initial amount of training data is greater than the second value, such that

q₀q₀>\hat{μ}+\sqrt{2}\hat{σ}ζdᵢ^{*}=0, then.

In some examples, the optimization component 118 may perform one or more processes when the CDF \hat{F} (q) is a noise estimate of an unknown true CDF F(q). For instance, suppose that the optimization component 118 estimates \hat{F}(q)˜ [symbol] (\hat{μ},\hat{σ}), but the true data requirement distribution is F(q)˜ [symbol] (μ,σ), where \hat{μ}, μ are the noisy estimated and true mean of D* and \hat{σ}, σ are the estimated and true standard deviations. As such, if \hat{μ}=μ and \hat{σ}=σ, then the optimization component 118 may determine that

$$R ( {d}_{1}^{*} ) \leq R ( \hat{μ} - {q}_{0} ) = \frac{P}{2} .$$

Additionally, if \hat{μ}≠μ and \hat{σ}=σ, then the optimization component 118 may determine that R(d₁^{*})≤R(\hat{μ}-q₀).

The process 100 may include the training component 104 using a collection component 120 to collect the training data for training the machine learning model(s) 102. In some examples, the collection component 120 may collect the training data from the data store 108 and/or one or more other sources. In some examples, such as when the machine learning model(s) 102 is being trained using various training stages, the collection component 120 may only collect the amount of training data that is associated with the current training stage for the machine learning model(s) 102. In some examples, such as when the collecting of the training data is associated with a cost, the collection component 120 may cause the cost for collecting the training data to be paid. In any of these examples, the training component 104 may then train the machine learning model(s) 102 using the collected training data, which is represented by 122.

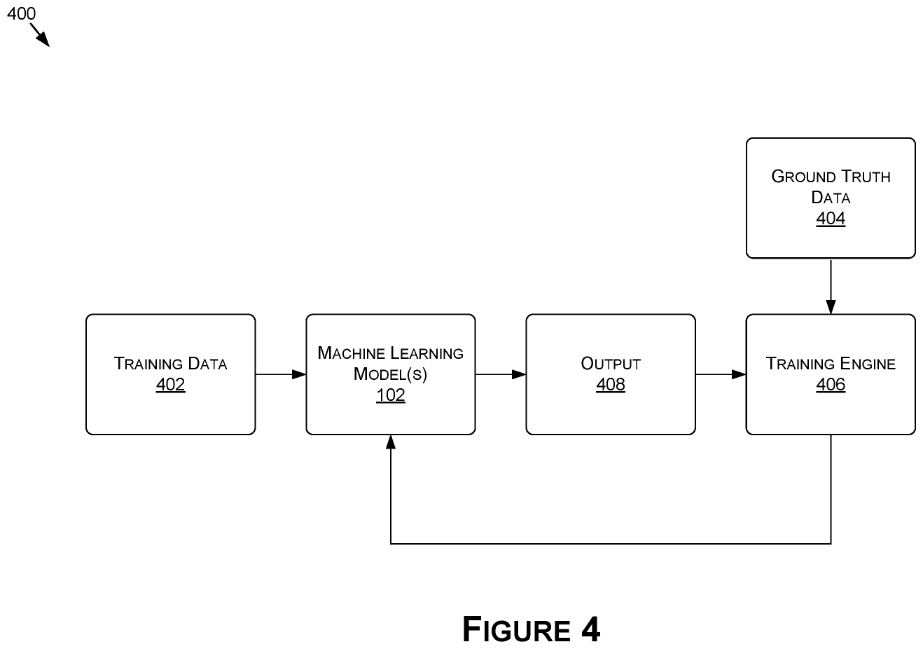

For instance, FIG. 4 is a data flow diagram illustrating a process 400 for training the machine learning model(s) 102, in accordance with some embodiments of the present disclosure. As shown, the machine learning model(s) 102 may be trained using training data 402. In some examples, such as when the machine learning model(s) 102 is being trained to detect objects within images, the training data 402 used for training may include original images (e.g., as captured by one or more image sensors), down-sampled images, up-sampled images, cropped or region of interest (ROI) images, otherwise augmented images, and/or a combination thereof. The training data 402 may be captured by one or more sensors (e.g., cameras, microphones, etc.), and/or may be captured from within a virtual environment used for testing and/or generating training images.

The machine learning model(s) 102 may be trained using the training data 402 as well as corresponding ground truth data 404. The ground truth data 404 may include annotations, labels, masks, and/or the like. The ground truth data 404 may be generated within a drawing program (e.g., an annotation program), a computer aided design (CAD) program, a labeling program, another type of program suitable for generating the ground truth data 404, and/or may be hand drawn, in some examples. In any example, the ground truth data 404 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof (e.g., human identifies vertices of polylines, machine generates polygons using polygon rasterizer). In some examples, for each training sample, there may be corresponding ground truth data 404.

A training engine 406 may include one or more loss functions that measure loss (e.g., error) in the outputs 408 as compared to the ground truth data 404. Any type of loss function may be used, such as cross entropy loss, mean squared error, mean absolute error, mean bias error, and/or other loss function types. In some embodiments, different outputs 408 may have different loss functions. In such examples, the loss functions may be combined to form a total loss, and the total loss may be used to train (e.g., update the parameters of) the machine learning model(s) 102. In any example, backward pass computations may be performed to recursively compute gradients of the loss function(s) with respect to training parameters. In some examples, weights and/or biases of the machine learning model(s) 102 may be used to compute these gradients.

Referring back to the example of FIG. 1, the process 100 may include the training component 104 using a verification component 124 to verify whether the training of the machine learning model(s) 102 is complete. For instance, after the machine learning model(s) 102 is trained using the collected training data, the verification component 124 may determine a current validation performance associated with the machine learning model(s) 102. The verification component 124 may then determine whether the current validation performance satisfies the target validation performance. If the verification component 124 determines that the current validation performance satisfies the target validation performance (e.g., the current validation score is equal to or greater than the target validation score), then the verification component 124 may determine that the training of the machine learning model(s) 102 is complete. As such, and in some examples, the verification component 124 may terminate the training of the machine learning model(s) 102.

However, if the verification component 124 determines that the current validation performance does not satisfy the target validation performance (e.g., the current validation score is less than the target validation score), then the verification component 124 may perform one or more additional processes. For example, the verification component 124 may determine whether the given time period associated with training the machine learning model(s) 102 has elapsed. If the verification component 124 determines that the given time period has elapsed, then the verification component 124 may again terminate the training of the machine learning model(s) 102 and/or pay the cost of not reaching the target validation performance and continue training the machine learning model(s) 102 to reach the target validation performance. However, if the verification component 124 determines that the given time period has not elapsed, then the verification component 124 may cause the training of the machine learning model(s) 102 to continue.

For example, and such as before a next training stage associated with the machine learning model(s) 102, the distribution component 116 may perform the processes described herein to determine an updated data requirement distribution (e.g., an updated CDF) for training the machine learning model(s) 102. In some examples, when determining the updated data requirement distribution, the distribution component 116 may use information about the actual training of the machine learning model(s) 102 that has already been performed. For example, the distribution component 116 may use information indicating the amount of training data that has already by used to train the machine learning model(s) 102 and/or the current validation performance of the machine learning model(s) 102 to determine the updated data requirement distribution. In some examples, the distribution component 116 uses the information by inserting the values associated with the information into one or more of the equations above.

The optimization component 118 may then use one or more of the processes described herein to determine an additional amount of training data needed to train the machine learning model(s) 102 in order to reach the target validation performance. In some examples, the optimization component 118 may use the updated data requirement distribution to determine the additional amount of training data. In some examples, the optimization component 118 may use the information about the actual training of the machine learning model(s) 102 that has already been performed. For example, the optimization component 118 may insert the values associated with the information into one or more of the equations above. For instance, and with regard to equation (5), the optimization component 118 may insert at least the amount of training data for the already performed training stage(s) into the variable for dₜ. Still, in some examples, the optimization component 118 may determine respective amounts of training data to collect at one or more (e.g., each) of the remaining training stage(s) associated with the machine learning model(s) 102.

The collection component 120 may then collect the additional training data, which the training component 104 may use to continue training the machine learning model(s) 102. In some examples, this process 100 may continue to repeat until the occurrence of one or more events. For a first example, this process 100 may continue to repeat until the verification component 124 determines that the current validation performance associated with the machine learning model(s) 102 satisfies the target validation performance associated with the machine learning model(s) 102. For a second example, this process 100 may continue to repeat until the verification component 124 determines that the given period of time associated with training the machine learning model(s) 102 has elapsed.

While the examples herein describe using the process 100 to determine an amount of training data to collect for training the machine learning model(s) 102, in some examples, the process 100 may be used to perform other types of processing. For a first example, if the machine learning model(s) 102 includes an already existing machine learning model 102 that is trained to perform a first task, such as detect a first class(es) of objects, a user may want to further train the machine learning model 102 to perform a second task, such as detect a second class(es) of objects. As such, the training component 104 may be used to determine an amount of training data that is needed to further train the machine learning model 102 to perform the second task with a target validation performance.

To determine the amount of data, the training component 104 may perform one or more of the processes described herein determine F(q) using training data that is associated with the first task for which the machine learning model 102 has already been trained. The training component 104 may use such training data since the training component 104 may not yet have any training data associated with the second task (e.g., q₀=0 for the second task). The training component 104 may then perform one or more of the processes described herein, using the determined F (q), to determine the amount of training data needed to train the machine learning model 102 to reach the target validation performance associated with the second task.

For a second example, the process 100 may be used to select between different methods for performing the same task. For instance, a user may have a choice between using a first method to perform a task, such as using a human that is associated with a first cost and a first accuracy, or a second method to perform the task, such as a machine learning model(s) 102 that is associated with a second cost and a second accuracy. In this example, more training data may be needed for the second method as compared to the first method since the human may make less mistakes than the machine learning model(s) 102. However, the cost of the second method may be less per sample of the training data as compared to the first method.

As such, the training component 104 may perform one or more of the processes described herein to determine a first final cost associated with using the first method and a second final cost associated with using the second method. In this example, if a high accuracy of performance is needed, then the second cost may be greater than the first cost. However, if a lower accuracy of performance is needed, then the first cost may be greater than the second cost. As such, the training component 104 may use the costs to determine the best method to use for performing the task.

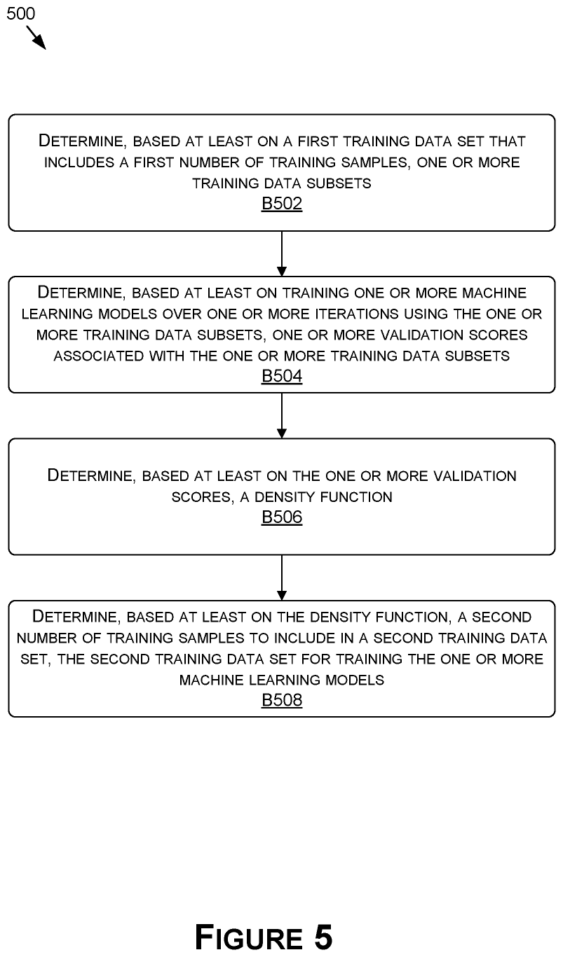

Now referring to FIGS. 5-7, each block of methods 500, 600, and 700, described herein, comprises a computing process that may be performed using any combination of hardware, firmware, and/or software. For instance, various functions may be carried out by a processor executing instructions stored in memory. The methods 500, 600, and 700 may also be embodied as computer-usable instructions stored on computer storage media. The methods 500, 600, and 700 may be provided by a standalone application, a service or hosted service (standalone or in combination with another hosted service), or a plug-in to another product, to name a few. In addition, the methods 500, 600, and 700 are described, by way of example, with respect to the process 100 of FIG. 1. However, the methods 500, 600, and 700 may additionally or alternatively be executed by any one system, or any combination of systems, including, but not limited to, those described herein.

FIG. 5 illustrates a flow diagram showing a method 500 for estimating an amount of training data for a machine learning model(s), in accordance with some embodiments of the present disclosure. The method 500, at block B502, may include determining, based at least on a first training data set that includes a first number of training samples, one or more training data subsets. For instance, the training component 104 (e.g., the distribution component 116) may use a first training data set 106 to generate the training data subset(s). As described herein, a training data subset may include a number of data sample (e.g., data points) such as, but not limited to, 10 samples, 20 samples, 50 samples, 100 samples, 1,000 samples, and/or any other number of samples. Additionally, the training component 104 may determine any number of the training data subset(s) such as, but not limited to, 1 subset, 5 subsets, 10 subsets, 50 subsets, and/or any other number of subsets.

The method 500, at block B504, may include determining, based at least on training one or more machine learning models over one or more iterations using the one or more training data subsets, one or more validation scores associated with the one or more training data subsets. For instance, the training component 104 (e.g., the distribution component 116) may iteratively train the machine learning model(s) 102 using the training data subset(s). Based at least on the training, the training component 104 may determine the validation score(s) associated with the training data subset(s). In some examples, the training component 104 may then use the validation score(s) to determine one or more estimated number of training samples needed for the machine learning model(s) 102 to reach a target validation performance.

The method 500, at block B506, may include determining, based at least on the one or more validation scores, a density function. For instance, the training component 104 (e.g., the distribution component 116) may use the validation score(s) to determine the density function. In some examples, the training component 104 determines the density function using the estimated number(s) of training samples. In some examples, the density function is a cumulative density function.

The method 500, at block B508, may include determining, based at least on the density function, a second number of training samples to include in a second training data set, the second training data set for training the one or more machine learning models. For instance, the training component 104 (e.g., the optimization component 118) may use the density function to determine the second number of training samples needed to train the machine learning model(s) 102 such that the machine learning model(s) 102 reaches a target validation performance (e.g., a target validation score). In some examples, the training component 104 uses one or more additional factors when determining the second number of training samples. For instance, the training component 104 may use one or more costs associated with generating and/or receiving the training data and/or a cost associated with failing to train the machine learning model(s) 102 to reach the target validation performance within a given period of time.

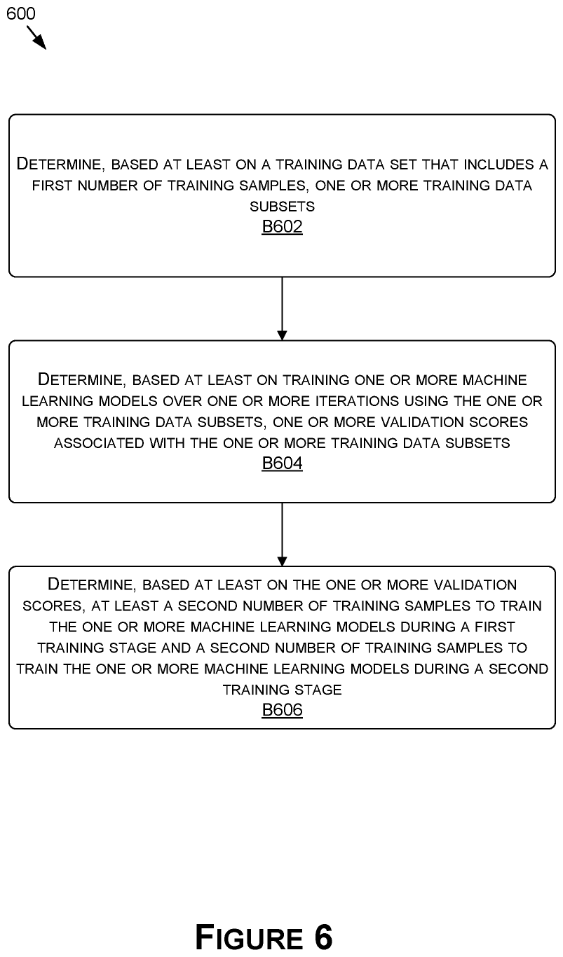

FIG. 6 illustrates a flow diagram showing a method 600 for estimating amounts of training data for training a machine learning model(s) at multiple training stages, in accordance with some embodiments of the present disclosure. The method 600, at block B602, may include determining, based at least on a training data set that includes a first number of training samples, one or more training data subsets. For instance, the training component 104 (e.g., the distribution component 116) may use the training data set 106 to generate the training data subset(s). As described herein, a training data subset may include a number of data samples (e.g., data points) such as, but not limited to, 10 samples, 20 samples, 50 samples, 100 samples, 1,000 samples, and/or any other number of samples. Additionally, the training component 104 may determine any number of the training data subset(s) such as, but not limited to, 1 subset, 5 subsets, 10 subsets, 50 subsets, and/or any other number of subsets.

The method 600, at block B604, may include determining, based at least on training one or more machine learning models over one or more iterations using the one or more training data subsets, one or more validation scores associated with the one or more training data subsets. For instance, the training component 104 (e.g., the distribution component 116) may iteratively train the machine learning model(s) 102 using the training data subset(s). Based at least on the training, the training component 104 may determine the validation score(s) associated with the training data subset(s). In some examples, the training component 104 may then use the validation score(s) to determine one or more estimated number of training samples needed for the machine learning model(s) 102 to reach a target validation performance.

The method 600, at block B606, may include determining, based at least on the one or more validation scores, at least a second number of training samples to train the machine learning models during a first training stage and a second number of training samples to train the one or more machine learning models during a second training stage. For instance, the training component 104 (e.g., the optimization component 118) may use the validation score(s) (e.g., the estimated number(s) of training samples) to determine the second number of training samples for training the machine learning model(s) 102 during the first training stage and the second number of training samples for training the machine learning model(s) 102 during the second training stage.

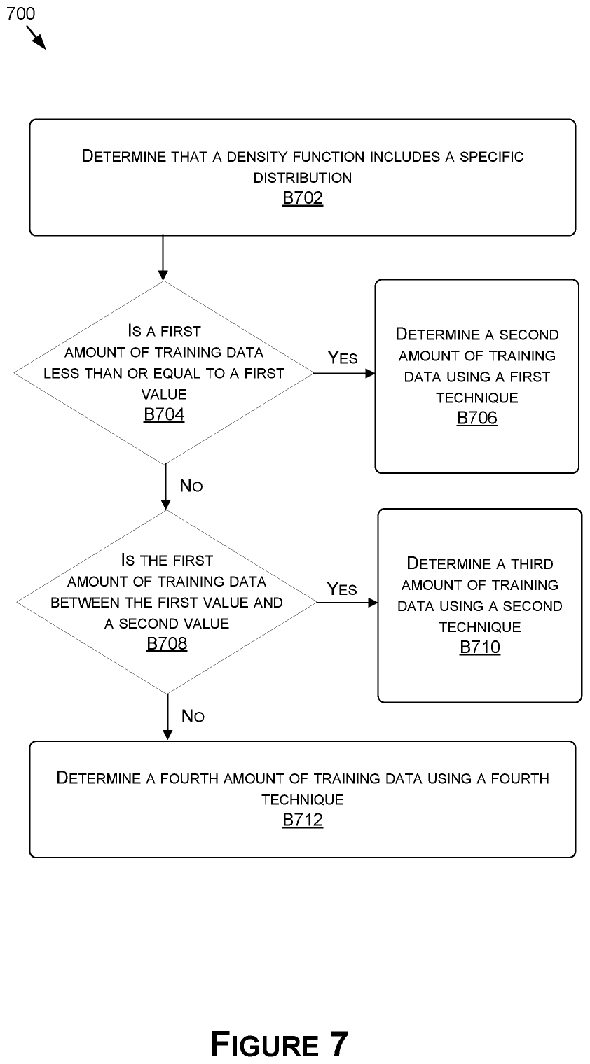

FIG. 7 illustrates a flow diagram showing a method 700 for estimating an amount of training data for specific types of density functions, in accordance with some embodiments of the present disclosure. The method 700, at block B702, may include determining that a density function includes a specific distribution. For instance, the training component 104 (e.g., the distribution component 116) may perform one or more of the processes described herein to determine the density function (e.g., a CDF). The training component 104 (e.g., the optimization component 118) may then determine that the density function includes the specific distribution. For instance, the training component 104 may determine that the density function includes a Gaussian distribution.

The method 700, at block B704, may include determining whether a first amount of training data is less than or equal to a first value. For instance, the training component 104 (e.g., the optimization component 118) may determine whether the first amount of training data, which the training component 104 may already have for training the machine learning model(s) 102, is less than or equal to the first value. If, at block B704, it is determined that the first amount of training data is less than or equal to the first value, then the method 700, at block B706, may include determining a second amount of training data using a first technique. For instance, if the training component 104 determines that the first amount of training data is less than or equal to the first value, then the training component 104 may determine the second amount of training data for training the machine learning model(s) 102 using the first technique. In some examples, the first technique may be associated with one or more first equations.

However, if, at block B704, it is determined that the first amount of training data is greater than the first value, then the method 700, at block B708, may include determining whether the first amount of training data is between the first value and a second value. For instance, if the training component 104 (e.g., the optimization component 118) determines that the first amount of training data is greater than the first value, then the training component 104 may determine whether the first amount of training data is between the first value and the second value. If, at block B708, it is determined that the first amount of training data is between the first value and the second value, then the method 700, at block B710, may include determining a third amount of training data using a second technique. For instance, if the training component 104 determines that the first amount of training data is between the first value and the second value, then the training component 104 may determine the third amount of training data for training the machine learning model(s) 102 using the second technique. In some examples, the second technique may be associated with one or more second equations.

However, if, at block B708, it is determined that the first amount of training data is not between the first value and the second value, then the method 700, at block B712, may include determining a fourth amount of training data using a third technique. For instance, if the training component 104 determines that the first amount of training data is not between the first value and the second value (e.g., the first amount of training data is greater than the second value), then the training component 104 may determine the fourth amount of training data for training the machine learning model(s) 102 using the third technique. In some examples, the third technique may be associated with no additional training data.

Example Computing Device

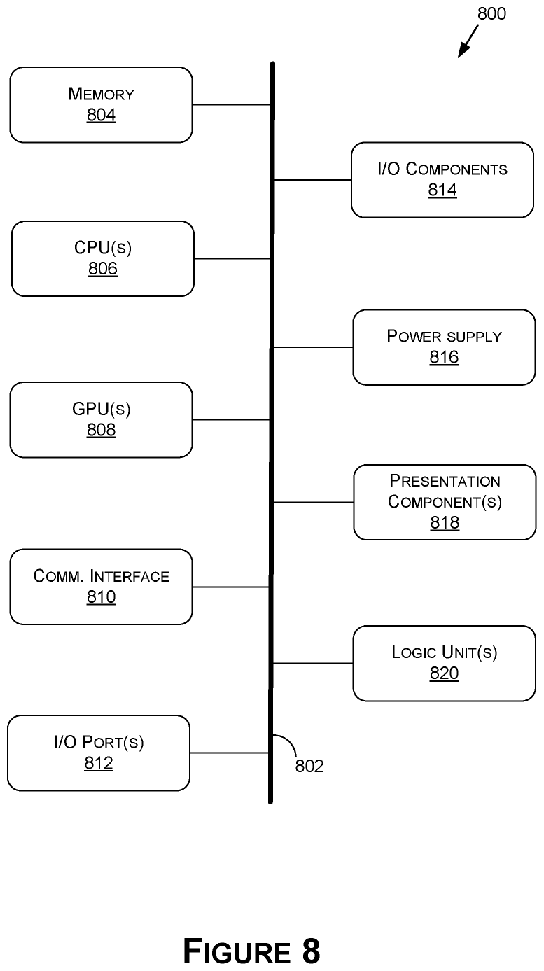

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). In other words, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that enable the computing device 800 to communicate with other computing devices via an electronic communication network, included wired and/or wireless communications. The communication interface 810 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may enable the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that enable detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to enable the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

Example Data Center

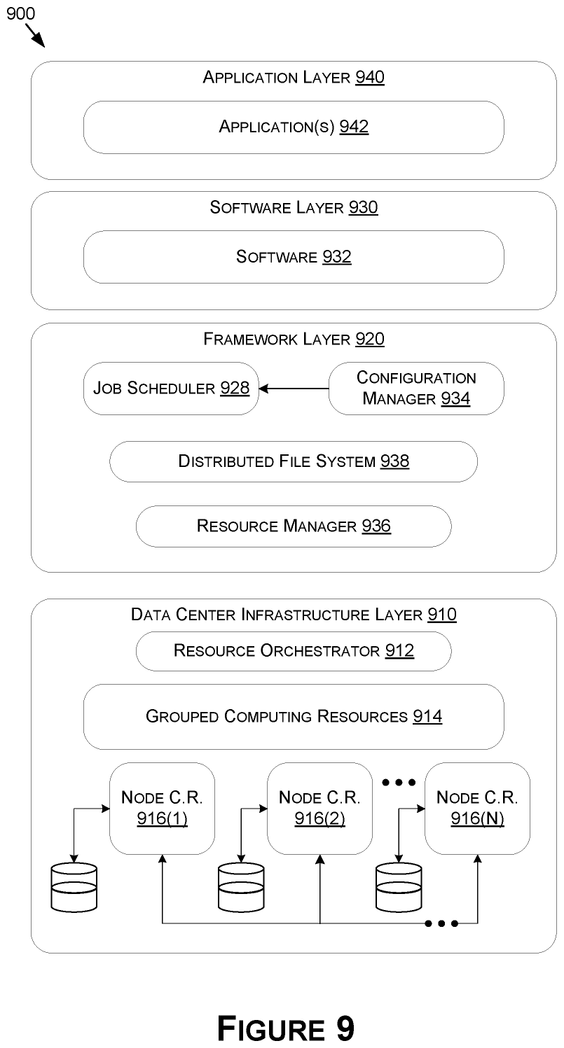

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 928, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 928 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 928. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining, based at least on a first data set that includes a first number of data samples, one or more data subsets;
determining, based at least on updating one or more machine learning models over one or more iterations using the one or more data subsets, one or more validation scores associated with the one or more data subsets;
determining, based at least on the one or more validation scores, a density function corresponding to an amount of data samples required to meet or exceed the one or more validation scores; and
determining, based at least on the density function, a second number of data samples to include in a second data set to update the one or more machine learning models.

2. The method of claim 1, further comprising:
updating, using the second data set, the one or more machine learning models during a first stage;
determining, based at least on the density function, a third number of data samples to include in a third data set; and
updating, using the third data set, the one or more machine learning models during a second stage.

3. The method of claim 2, further comprising:
determining, based at least on updating the one or more machine learning models using the second data set, a validation score associated with the one or more machine learning models; and
determining, based at least on the second number of data samples included in the second data set and the validation score, a fourth number of data samples to include in the third data set.

4. The method of claim 3, further comprising:
determining, based at least on the first data set that includes the first number of data samples, one or more second data subsets;
determining, based at least on updating the one or more machine learning models over one or more second iterations using the one or more second data subsets, one or more second validation scores associated with the one or more second data subsets; and
determining, based at least on the one or more second validation scores, a second density function,
wherein the determining the fourth number of data samples to include in the third data set is further based at least on the second density function.

5. The method of claim 1, wherein the determining the second number of data samples to include in the second data set is further based at least on one or more costs, the one or more costs associated with at least one of:
collecting the second number of data samples; or
a risk that a validation performance for the one or more machine learning models is less than a target validation performance after a period of time elapses.

6. The method of claim 1, further comprising:
determining a target validation performance associated with the one or more machine learning models,
wherein the determining the second number of data samples to include in the second data set is further based at least on the target validation performance.

7. The method of claim 1, further comprising:
determining, based at least on the one or more validation scores and a target validation performance, one or more estimated number of data samples for updating the one or more machine learning models,
wherein the determining the density function is based at least on the one or more estimated number of data samples.

8. The method of claim 7, wherein:
the one or more data subsets comprises at least a first group of data subsets and a second group of data subsets;
the one or more validation scores comprises at least one or more first validation scores associated with the first group of data subsets and one or more second validation scores associated with the second group of data subsets; and
the determining the one or more estimated number of data samples for updating the one or more machine learning models comprises:
determining, based at least on the one or more first validation scores and the target validation performance, a first estimated number of data samples for updating the one or more machine learning models; and
determining, based at least on the one or more second validation scores and the target validation performance, a second estimated number of data samples for updating the one or more machine learning models, the one or more estimated number of data samples including at least the first estimated number of data samples and the second number of data samples.

9. The method of claim 1, further comprising:
determining, based at least on updating the one or more machine learning models using the second data set, a validation score associated with the one or more machine learning models; and
one of:
based at least the validation score being less than a target validation score, determining a third number of data samples to include in a third data set, the third data set for updating the one or more machine learning models; or
based at least on the validation score being equal to or greater than the target validation score, determining that the updating of the one or more machine learning models is complete.

10. A system comprising:
one or more processing units to:
determine, based at least on a first data set that includes a first number of data samples, one or more data subsets;
determine, based at least on updating one or more machine learning models over one or more iterations using the one or more data subsets, one or more validation scores associated with the one or more data subsets; and
determine, based at least on the one or more validation scores, at least:
a second number of data samples to include in a second data set, the second data set to update the one or more machine learning models during a first stage; and
a third number of data samples to include in a third data set, the third data set to update the one or more machine learning models during a second stage.

11. The system of claim 10, wherein the one or more processing units are further to:
determine, based at least on updating the one or more machine learning models using the second data set, a validation score associated with the one or more machine learning models; and determine, based at least on the second number of data samples included in the second data set and the validation score, a fourth number of data samples to include in the third data set.

12. The system of claim 10, wherein the one or more processing units are further to:
determine, based at least on the one or more validation scores, a density function,
wherein the determination of the at least the second number of data samples to include in the second data set and the third number of data samples to include in the third data set is based at least on the density function.

13. The system of claim 12, wherein the one or more processing units are further to:
determine, based at least on the one or more validation scores and a target validation performance, one or more estimated number of data samples for updating the one or more machine learning models,
wherein the determination of the density function is based at least on the one or more estimated number of data samples.

14. The system of claim 13, wherein:
the one or more data subsets comprise at least a first group of data subsets and a second group of data subsets;
the one or more validation scores comprises at least one or more first validation scores associated with the first group of data subsets and one or more second validation scores associated with the second group of data subsets; and
the determination of the one or more estimated number of data samples for updating the one or more machine learning models comprises:
determining, based at least on the one or more first validation scores and the target validation performance, a first estimated number of data samples for updating the one or more machine learning models; and
determining, based at least on the one or more second validation scores and the target validation performance, a second estimated number of data samples for updating the one or more machine learning models, the one or more estimated number of data samples including the first estimated number of data samples and the second number of data samples.

15. The system of claim 10, wherein the determination of the at least the second number of data samples to include in the second data set and the third number of data samples to include in the third data set is further based at least on one or more costs, the one or more costs associated with at least one of:
collecting the second number of data samples and the third number of data samples; or
a risk that a validation performance for the one or more machine learning models is less than a target validation performance after a period of time elapses.

16. The system of claim 10, wherein the one or more processing units are further to:
determine a target validation performance associated with the one or more machine learning models,
wherein the determination of the one or more validation scores is further based at least on the target validation performance.

17. The system of claim 10, wherein the one or more processing units are further to:
receive input data representative of at least one of a number of stages or a period of time associated with updating the one or more machine learning models,
wherein the determination of the at least the second number of data samples to include in the second data set and the third number of data samples to include in the third data set is further based at least on the at least one of the number of stages or the period of time.

18. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing operations using a language model;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

19. A processor comprising:
one or more processing units to determine, based at least on a density function associated with a data set, a number of data samples for updating one or more machine learning models, wherein the density function is determined based at least on updating the one or more machine learning models over one or more iterations using one or more data subsets.

20. The processor of claim 19, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing operations using a language model;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
